(19) United States
(12) Patent Application Publication
(10) Pub. No.: US 2009/0045258 A1
(43) Pub. Date: Feb. 19, 2009

(54) METHOD & SYSTEM FOR ENFORCING A RETURN POLICY

(76) Inventor: Anton Sabeta, Toronto (CA)

Correspondence Address: SABETA IP, 283 DANFORTH AVE, SUITE 184, TORONTO, ON, M4K-1N2, CA

(21) Appl. No.: 12/189,259

(22) Filed: Aug. 11, 2008

Related U.S. Application Data
(60) Provisional application No. 60/955,377, filed on Aug. 12, 2007.

(51) Int. Cl. G06F 19/00

(52) U.S. Cl. 235/385

(57) ABSTRACT

A method and system for enforcing a return policy by determining whether an article of merchandise has been, used, or not used, within a predetermined time after the purchase of the merchandise. The system including sensor means associated with the article for recording data related to ambient conditions post-purchase, data acquisition means for receiving the recorded data, a comparator for comparing the recorded data to a predefined data set representative of acceptable data values, output means for outputting an outcome from the comparator, the outcome being indicative of whether the article has been used, or not used.

### CROSS-REFERENCE TO RELATED APPLICATIONS

This application claims the benefit of priority to U.S. Provisional Application Ser. No. 60/955,377 filed Aug. 12, 2007.

### BACKGROUND OF THE INVENTION

1. Field of the Invention

The present invention relates to a return fraud mitigation system, more specifically it relates to enforcing a return policy by determining whether an article of merchandise has been used, or not used, within a predetermined time after the purchase of the article.

2. Description of the Prior Art

The problem of merchandise return fraud, although kept as a close industry secret, is a tremendous problem. Merchandise return transactions can reach as high as fifteen to twenty percent of a retailer's total sales. Unfortunately, not all return transactions are legitimate, and so for retailers with sales in the range of billions of dollars per year, such return transactions can result in losses in the range of millions of dollars per year. According to a recent report by the National Retail Federation, fraudulent returns cost retailers 9.6 billion dollars annually. The National Retail Federation also states that nearly two-thirds of merchants had items wardrobed in 2007, up from 56 percent the year before.

Return fraud includes a variety of forms, such as, stealing merchandise from one retailer and then returning that merchandise for a refund at the same retailer or to any other participating retailer. Another form of return fraud involves buying merchandise at sale prices and then returning the merchandise for a full priced refund at a later date. Even employees at retailers may be involved in return fraud; this scheme entails keeping the receipts from previous sales and using them to process refunds later on. In some businesses, depending on the procedures followed, staff members may be able to process a fraudulent refund even without a receipt.

Another form of return fraud is called “renting or wardrobing” and is a result of a ‘short-term purchase’ where goods are purchased and used for a short time, and then returned immediately after their use a customer returning merchandise that has been used, for a full refund. These returns include items such as consumer electronics or clothing. For example, individuals might purchase these items to use for special occasions, such as, a graduation, Christmas party or wedding. In one example, a person purchases a special-occasion dress, wears the dress, while tucking away the sales tag, and then returns the dress to the store for a full refund. In many cases, retailers cannot resell these goods, at least not for the full retail price, so the retailer is forced to discount the item as used merchandise. This fraudulent practice is difficult to recognize, as it is currently left to humans to establish whether the merchandise has be used, worn, washed or dry-cleaned. Among the ways for determining whether a item has been used are: wrinkles, spots stains, soils, odors, broken seal, opened, or repackaging or incorrect repackaging. Therefore, the process of determining whether the return policy is being adhered to is rather subjective and oftentimes leads to inaccurate assessments and results. Another drawback of having retail staff make the judgement call for what is returnable, or not, is that such current systems can, and often be overridden as the retail staff may be swayed by convincing customers to accept items for return despite violation of the return policy, or the retail staff may allow returns of ineligible items for friends, family or accomplices. As such, ineligible items for returns may end up back in the inventory and are subsequently unsuitable to be sold or have to be discounted. The majority of shoppers who wardrobe do not think hey are doing anything wrong, a 2008 online poll found that 73% of all respondents felt that wardrobing was neither illegal or unethical.

Retailers have countered against return fraud with higher retail prices or tougher return policies, such as, the “no receipt, no return” policy, “store credit regardless of the form of tender used”, “restocking fees”, or “the final sale/no return” policy”. Some retailers are also using the services of The Retail Equation of Irvine, Calif., U.S.A., which provides fraud and abuse detection products to track excessive or illegal merchandise returns. When a customer returns an item, the retail staff swipes the customer's driver's license or other suitable form of identification, and the system issues the return history of the customer including details of the returned items and their value. Based on this information, the retail staff decides whether the return is allowable. As such, retailers are being forced to strike a delicate balance between servicing loyal shoppers and discouraging opportunistic criminals.

However, to date, there is still no satisfactory solution to deter and/or detect the phenomenon of return fraud, and the retail industry continues to suffer from this practice.

It is an object of the present invention to mitigate or obviate at least one of the above-mentioned disadvantages.

### SUMMARY OF THE INVENTION

In one of its aspects the present invention provides a method for enforcing a return policy relating to an article of merchandise following a predetermined event, the method having the steps of:

including at least one sensor with said article, said sensor for logging and recording ambient conditions data,

including article data related to the article in said sensor;

said sensor being located in predefined locations on said article to log ambient conditions data adjacent to said sensor;

acquiring said ambient conditions data from said sensors;

comparing said ambient conditions data to predetermined parameters associated with said return policy and analyzing said ambient conditions data to determine whether said recorded ambient conditions data is within the predetermined parameters or outside the predetermined parameters;

issuing an output signal indicative of the outcome of said step of comparing said ambient conditions data to predetermined parameters;
wherein the output signal is correlated to article use or non-use following said predetermined event, and wherein said article is eligible for return based on said output signal and elapsed time following said predetermined event.

In another of its aspects, the present invention provides a system for mitigating return fraud of an article of merchandise following a predetermined event, the system including:

sensor means associated with the article for recording data related to ambient conditions post-purchase, said sensor means having data acquisition means for receiving the recorded data;

a return policy engine comprising an analysis engine, said analysis engine for receiving data from said data acquisition means; a merchant database, a customer database, return policy, database and a parameter database with predetermined ambient conditions data coupled thereto, to determine whether an article has been used or not used based on recorded data and predetermined ambient conditions data;

whereby said eligibility for return of said article is based on at least an outcome of a comparison between recorded data and predetermined ambient conditions data, elapsed time following said predetermined event, including merchant data, customer data and return policy data.

In another of its aspects, the present invention provides a method for mitigating return fraud by detecting the use or non-use of an article of merchandise after a predetermined event to determine whether said article is eligible for return to a merchant, the method having the steps of:

including: at least one sensor with said article, said sensor for logging and recording ambient conditions data;

including data related to the article in said sensor;

said sensor being located in predefined locations on said article to log ambient conditions data adjacent to said sensor;

acquiring said ambient conditions data from said sensors;

comparing said ambient conditions data to predetermined parameters and analyzing said ambient conditions data to determine whether said recorded ambient conditions data is within the predetermined, parameters or outside the predetermined parameters;

issuing an output signal indicative of the outcome of said step of comparing said ambient conditions data to predetermined parameters, said output signal being correlated to article use or non-use following said predetermined event;

determining the elapsed time following said predetermined event; wherein eligibility for return for said article is based on said output signal and said elapsed time following said predetermined event.

In one of its aspects, the present invention provides a method for verifying the use or non-use of an article within a predetermined time after the purchase of the article, the method including the steps of including a plurality of sensor means with the article, the sensor means for measuring, gathering information related to the environment adjacent the sensor means and recording the acquired data, analyzing the recorded data to determine whether the recorded data corresponds to parameters consistent with an environment in which an article has been used or not used, the step of analyzing including a further step for comparing recorded data to predetermined data corresponding to an environment indicative of use of the article.

In another of its aspects, the present invention provides a return fraud mitigation system having the features for accurately determining whether an article has been used, or not used, within a predetermined time after the purchase of the article. The system including sensor means associated with the article for recording data related to ambient conditions post-purchase, data acquisition means for receiving the recorded data, a comparator for comparing the recorded data to a predefined data set representative of acceptable data values, output means for outputting an outcome from the comparator, the outcome being indicative of whether the article has been used, or not used.

Advantageously, the return fraud mitigation and/or prevention system of the present invention incorporates features for accurately determining whether an article has been used, or not used, within a predetermined time after the purchase of the article. This method and system is, substantially effective as a deterrence to would be fraudsters, and aids the retailer in enforcing the return policy.

### BRIEF DESCRIPTION OF THE DRAWINGS

Several preferred embodiments of the present invention will now be described, by way of example only, with reference to the appended drawings in which:

FIG. 1 shows an exemplary return fraud mitigation system;

FIG. 2 shows exemplary steps for a method of mitigating return fraud; and

FIG. 3 shows a block diagram of an exemplary sensor.

### DESCRIPTION OF THE PREFERRED EMBODIMENTS

The detailed description of exemplary embodiments of the invention herein makes reference to the accompanying block diagrams, schematic diagrams, and flowcharts, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data net working, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be, present in a practical system.

The present invention may be described herein in terms of block diagrams, screen shots and flowcharts, optional selections and various processing steps. Such functional blocks may be realized by any number of hardware and/or software components configured to perform to specified functions. For example, the present invention may employ various integrated circuit components (e.g., memory) elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERI, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

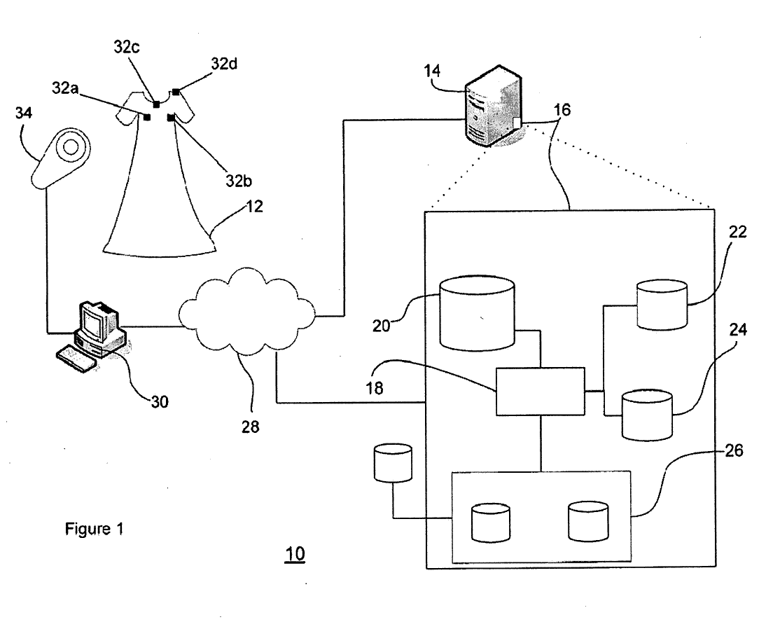

FIG. 1 illustrates a system 10 for mitigating, return fraud of articles or merchandise 12, especially in the retail industry. The system 10 includes a first computing entity 14 having a return policy engine 16 having instructions executable for enforcing at least one return policy. The return policy engine includes, among others, a plurality of databases coupled to an analysis engine 18, such as, a customer database 20, a return policy database 22, a merchant database 24 and a parameter database 26. For example, the merchant database 24 may include any of the following information, but not limited to, description of the merchandise, pricing data, sale or markdown data, gift item, inventory data, SKU, merchant data, customer data, purchased merchandise data, returned merchandise data, statistical data, or a combination thereof. The server 14 is coupled to a network 28, and exchanges data with at least one second computing entity 30, also coupled to the network 28. The second computing entity 30 may be return station, for processing returned articles 12.

Typically, computing entities 14, 30 include a digital data processing-device having a processor, a computer readable medium and input/output means. Processor refers to the logic circuitry that responds to and processes instructions that drive digital data processing, devices such as, without limitation, a central processing unit, an arithmetic logic unit, an application specific integrated circuit, a task engine, and/or combinations, arrangements, or multiples thereof. Instructions for programs or other executables can be pre-loaded into a programmable memory that is accessible to the processor and/or can be dynamically loaded into/from one or more volatile (e.g., RAM, cache, etc.) and/or non-volatile (e.g., a hard drive, optical disk, compact disk (CD), digital video disk (DVD), magnetic disk, magnetic tape, internal hard drive, external hard drive, random access memory (RAM), redundant array of independent disks (RAID), IC memory card, flash memory, or removable memory device) memory elements communicatively coupled to the processor. The computing entities 14, 30 may include a personal computer (PC), a computer workstation, a laptop computer, a server computer, a client computer, a mainframe computer, a wearable computing device, a handheld device (e.g., a personal digital assistant (PDA), a mobile telephone, an e-mail device, a smart phone, a wrist watch, an information appliance, and/or another type of generic or special-purpose, processor-controlled device capable of receiving, processing, and/or transmitting digital data.

For example, the instructions can correspond to the initialization of hardware within the digital data processing devices; an operating system that enables the hardware elements to communicate under software control and enables other computer programs to communicate, and/or software application programs that are designed to perform operations for other computer programs. Thus, a set of instructions is included in the computer-readable medium is for performing operations or functions related to the system 10 or the operation of the digital data processing device 14 or 30. A user can interact with the system 10, for example, viewing a command line, using a graphical and/or other user interface, and entering commands via an input device, such as a mouse, microphone, a keyboard, a touch sensitive screen, a stylus, a track ball, a keypad, etc., and receiving advisory signals via output means such as display means, speaker, LEDs, and so forth. Inputs from the user can be received via an input/output (I/O) subsystem and routed to processor via an internal bus (e.g., system bus) for execution under the control of the operating system. The input/output means for interacting with the system 10 may be embodied within the digital data processing device 14 or 30, such as the graphical user interface, display means, a touch screen display, stylus, keypad, keyboard, buttons, a microphone, and a speaker.

The network 28 can include a series of network nodes (e.g., the clients and servers) that can be interconnected by network devices and wired and/or wireless communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a server node regardless of dissimilarities in the network topology (e.g., bus, star, token ring), spatial distance (e.g., local, metropolitan, wide area network, internet), transmission technology (e.g., TCP/IP, Systems Network Architecture), data type (e.g., data, voice, video, multimedia), nature of connection (e.g., switched, non-switched, dial-up, dedicated, or virtual), and/or physical link (e.g., optical fiber, coaxial cable, twisted pair, wireless, etc.) between the originating and server network nodes.

The merchandise 12 may include any articles that are eligible for return to a merchant, such as, but is not limited to, items of clothing, footwear, eyewear, headgear, garments, jewellery, accessories, handbags, purses, timepieces, computing devices, consumer electronics and associated accessories, furniture, appliances, recreational toys, dolls, personal hygiene products, cosmetics, fragrances, media products, print media, books, floor covers, linens, blankets, bedding, consumables; food, drinks, water recreational products, vehicles (motorized or non-motorized) products and accessories and parts, pet products & accessories; household items, yard or garden items, tools, power tools, paint, lumber, construction products, light sources, and so forth. The eligibility criterion for a returnable item 12 typically includes: non-use, or non-use within a predetermined time post-purchase of the merchandise, original packaging, merchandise tags in place, unworn, unwashed, unlaundered, non-dry-cleaned, ironed, and so forth. However, the criteria may also include use or acceptable use within a predetermined time post-purchase of the merchandise; or reasonable use within certain parameters. An exemplary return policy for a retailer dictates:

“Our store WILL NOT accept any returns or exchanged items if:
1. The goods are not in their ORIGINAL CONDITION.
2. If any of the tags have been removed totally and then re-attached.
3. If a garment has been used or worn.
4. If a garment has been washed.
5. If a garment has been used or worn, and or has foundation marks, deodorant marks or smells of perfume/after-shave/deodorant.
6. If the garment was purchased more than 14 days before the date of the return.”

In an exemplary embodiment, the article 12 includes a plurality of devices 32a-d, located at various locations on the article 12. Typically, the devices 32a-d may be dimensioned to be undetectable by the naked human eye. Generally, certain devices 32a-d are located at predefined locations, and are programmed to acquire readings or values related to the ambient conditions at or adjacent to predefined locations on the merchandise. The ambient conditions, or environmental conditions may include, but are not limited to, temperature, humidity, moisture, pH, chemicals, smoke, vibration, light, radiation, acoustic, magnetic fields, pulse, vital signs, air quality, power, motion, global positioning, geo-location, orientation, acceleration, or changes thereof, and so forth. The devices 32a-d thus store the acquired data on a computer readable medium, this data is transmitted to a reader or interrogator 34 coupled to the point of return station 30, following an interrogation by the reader 24. Each of the devices 32a-d may be uniquely identifiable, and may be assigned to measure one or more environmental variable. The devices 32a-d may also include customer data, and/or merchandise data. For example, the system 10 may provide a computer program product encoded in a computer-readable medium including a plurality of computer executable steps for a digital data processing device 14 or 30 for processing the data received from the devices 32a-d. As an example, the reader 34 may be coupled to the second computing device 30, or the server 14, via a wired or wireless connection, such as Ethernet, IEEE 1394, TDMA, CDMA, GSM, EDGE, PSTN, ATM, ISDN, 802.1X, USB, Parallel, Serial, UART (RS-232C), among others.

In one example, an item of clothing 12 includes a plurality of devices 32a-d located at/or adjacent to various points of the shirt 12, such as chest region (32a), the armpit region (32b), the collar regions (32c), and the shoulder region (32d), so that any or all of these devices 32a-d may sense any one of the above-noted ambient conditions. Each of these devices 32a-d are so positioned and programmed to monitor predefined conditions and acquire specific measurements, for example device 32a may be programmed to measure and record vital signs, such as heart beat, breathing rate or breathing amplitude, such as a piezoelectric sensor, whereas device 32b may measure and record temperature (e.g. body temperature), or temperature deltas near the armpits, device 32c may record global positioning (GPS) data, geolocation data, and device 32d may record acoustic energy, and so forth. The devices 32a-d may be included with the hang-tags associated with the clothing. Alternatively, device 32b may be a pH sensor for monitoring the pH of sweat, or a sweat rate sensor, to determine the level of activity of the wearer. The item of clothing 12 may also include strain sensors 32 for monitoring of the movements of limbs.

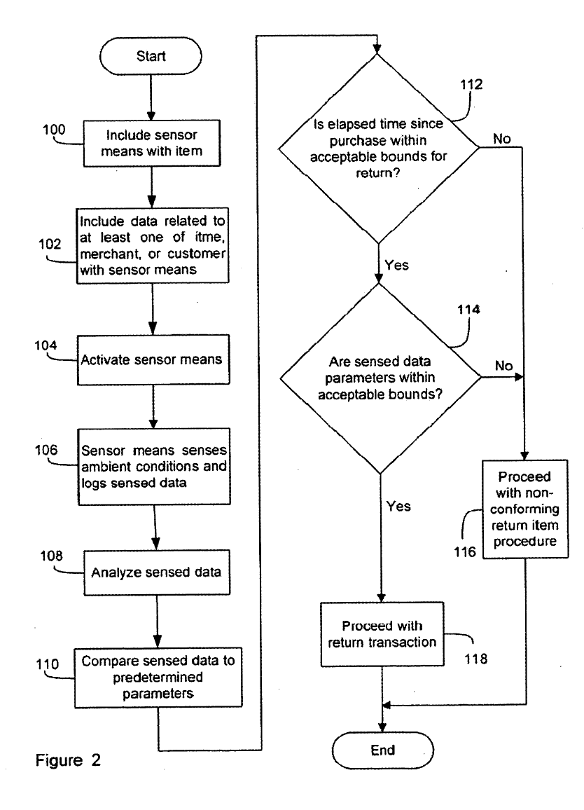

As shown in FIG. 2, in another exemplary embodiment, the present invention provides a method for detecting the use of an article 12 after a predetermined event, the method having the steps of: including sensor means 32 with the article 12, the sensor means for logging and recording ambient conditions data (step 100); including data related to the article 12 in the sensor means 32, the data including any of the following, but not limited to, date of purchase, merchant data, inventory data, SKU, method of payment, customer data, salesperson data, point of sale data (step 102); activating the sensor means tag 32 (step 104) being located at a predefined location on the article 12 to acquire and log ambient conditions data adjacent to the sensor means 32 (step 106); analyzing the sensed data (step 108); comparing the sensed ambient conditions data to predetermined parameter (step 110); determine whether the elapsed time since purchase is within acceptable bounds for return (step 112); determine whether the sensed ambient conditions data is within the predetermined parameters or outside the predetermined parameters (step 114); issuing an output signal indicative of the outcome of the step of comparing the ambient conditions data to predetermined parameters (step 116, 118); wherein the output signal is correlated to article 12 use or non-use following the predetermined event. Additionally, other data such as merchant data or inventory is verified to ensure authenticity of the item or purchase store, in accordance with the return policy. For instance, the return policy may dictate that returns must be made at an original point of purchase, such as the purchase store.

In another example, a book or a magazine includes temperatures sensing devices 32a-d or transducers to detect holding of the books or magazine during reading. The book or magazine may include light sensing devices 32a-d on all or random pages to detect exposure to light, or length of exposure, which may be used to determine whether the book or magazine was read and for how long, or copied.

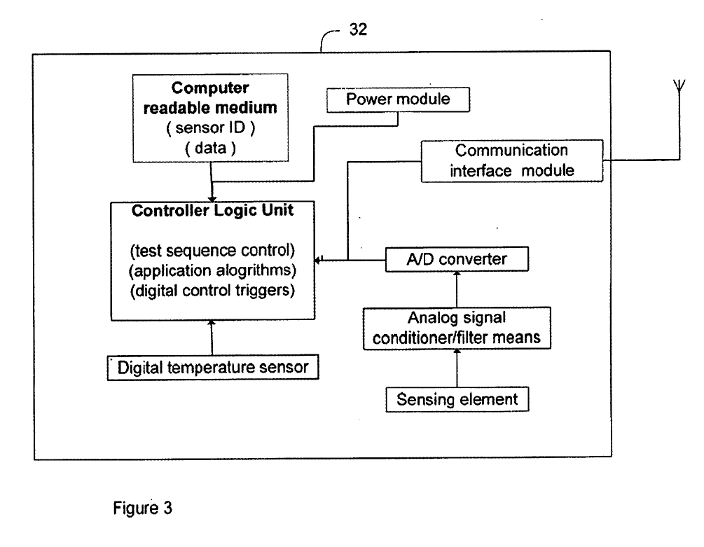

Generally, the devices 32a-d produce measurable response to a change in a physical condition, and the continual analog signal sensed by the devices 32a-d is digitized by an analog-to-digital converter and sent to controllers for further processing. Typical characteristics and requirements of a sensor node 32a-d call for a relatively small size, and consume extremely low energy, being autonomous and able to operate unattended, and being adaptive to the environment. The devices 32a-d may be passive, semi-active or active. An exemplary sensing device 32 is shown in FIG. 3 is a self-contained unit having sensing elements, data loggers with non-volatile memory, and power source means such as RF power or photovoltaic power. The internal software runs multi-phased, variable-interval test sequences that collect highly accurate data. The controller logic unit performs important functions, such as providing information such as the sensor type and location, as well as calibration factors. It also provides dynamic information such as recording status, memory capacity, and battery level. The controller logic unit may also execute specific application algorithms to process the raw data to produces a digital data output. The non-volatile memory serves as data storage for the sensor 32.

The output from the temperature sensing element is an analog signal, which feeds into an analog signal conditioner. The signal conditioner cleans and filters the incoming signal and passes it on to an A/D converter. The A/D converter converts the analog signal into a digital signal for input to the central controller logic unit. Also, feeding into the controller unit is a real-time clock, enabling all readings to be date and time stamped. The sensor 32a also includes a communications interface, such as an RF interface, for communicating with the reader 34; or other sensors 32b-d.

In another exemplary embodiment, the device 32 is a wireless sensor tag, wherein the sensor gathers information from the environment through measuring various phenomena, as stated above. The sensor 32 may transmit the acquired data via an RFID interface, and may be active, semi-active or passive. The device 32 uses a power source, such as an energy storage and/or energy scavenging device. An energy storage device may be a battery, a Zn-air cell, or a capacitor. An energy scavenging device may include energy from the environment, such as radiation (solar, RF, and so forth), or photovoltaic energy. Other sources include vibration spectra of office windows, copy machines, microwave ovens, industrial motors, freeway traffic, RF power, or human gait. As an example, a MEMS battery provides roughly 1 J/mm³, a solar cell provides approximately 100 uW/mm² in full sunlight, more than 100 nW/mm² in average room lighting. Vibrational energy available in an office setting is in the nW/mm³ range, and RF power generates microwatts. Typically, only a few nanojoules of energy are required for performing the tasks of sampling a sensor, or performing some processing (threshold, FIR/IIR filtering, statistical analysis, or FFT), listening for incoming messages, and transmitting a simple outgoing message. Therefore, a cubic millimetre battery could provide enough power to perform such a simple task once a second for 10 years, and so a cubic millimeter vibrational energy rectifier or a square millimeter solar cell would provide ample energy for acquiring digital data sample from a plurality sensors 32, threshold detection at discrete time periods requires substantially little energy in most cases, and so the above-noted are more than sufficient to support the power requirements for the device 32.

As an example, determination as to whether an item of clothing 12 has been worn may be accomplished by measuring the sweat rate via sweat sensors 32 associated with the clothing 12. Typically, adults have an average sweat loss of about 500-700 ml/day in mild climate conditions (T=25° C., relative humidity=50%). If an average value of 1.7 m² is used for the body surface area, a range of possible sweat rates can be calculated (0.2-40 g/m² min). Therefore, any acquired measurements substantially within this range are indicative of the presence of sweat, which is most likely a consequence of the item of clothing being worn.

In a merchandise return situation, the predetermined event may be the time of purchase, and the point of return would typically be at a customer service counter which may also incorporate a point-of-sale device, such as a cash register. Upon presentation of an article of merchandise 12 to be returned, the store clerk or other individual responsible for processing merchandise returns would present the article 12 to the reader 34, or vice-versa, in order to interrogate the devices 32a-d. For example, where the returned merchandise is an item of clothing 12, the device 32a would data related to vital signs, such as heart beat or pulse, and the device 32b would output temperature measurements recorded near the armpits, and device 32c would provide global positioning data to indicate locations the clothing has been since the purchase date, and device 32d would provide acoustic, energy readings or decibel levels. The acquired data, and the associated time of recordal by the devices 32a-d, is then analysed or compared to the expected ambient conditions values in database 24 in order to detect any inconsistency or discrepancy since the purchase date. For example, if the acquired temperature readings are in the vicinity of a normal person's body temperature, and/or are higher than room temperature or outside temperature, then this data would be inconsistent with a non-wear or non-use of the item 12. As an embodiment to customer privacy the store clerk is only directed to permit or deny the return of the item, and may not be permitted to access to underlying data. However, a customer may elect to have access or view to the underlying data in the case of a dispute regarding the return policy, such as instances when an item is deemed ineligible for return. Said access to the data may be communicated to the customer via any means of communication, such as snail mail, email, fax, IM, SMS, telephone, website, or an in-store display means, such as a POS or customer service station.

In another exemplary embodiment, the devices 32a-d are part of a location based system (LBS), or are in communication with an LBS, or include a transmission node 32c for coupling to the network 18 to exchange data with the computing entities 20 or database 16. The devices 32a-d may provide GPS data, or geo-location data which may be used in conjunction with other monitoring systems, such as, surveillance systems, to capture images adjacent to the location reported by the devices 32a-d. Geo-location may be obtained via triangulation methods, such as RF base stations/cell-towers etc. Such images, along with the other sensed data, may be used to determine use or non-use of the merchandise 12.

In another exemplary embodiment, the devices 32a-d include at least one sensor assigned to measure one or more environmental variables, and may communicate with the other devices 32a-d, and transmit their acquired data, such that each of the devices 32a-d includes the acquired data of all other devices-32a-d. As such, the spatially distributed autonomous devices 32a-d may form a wireless sensor network using sensors to cooperatively monitor physical or environmental conditions, such as temperature, sound, vibration, pressure, motion or chemical or biological agents, at different locations. Alternatively, certain devices 32a-d are designated to receive acquired data from other devices 32a-d.

A sensor node 32a, b, c, or d, or mote, within the wireless sensor, network, is capable of performing processing, gathering sensory information and communicating with other connected nodes 32a, b, c, or d in the network. Typically, the mote 32a, b, c, or d is a computing entity having a programmable microprocessor, a transceiver (circuitry for transmitting and receiving data) a power source, antenna, and a computer readable medium for instructions and data storage. The microprocessor integrated circuit provides sensor signal processing, communication, control, monitoring other motes 32a-d, data storage and energy management. As an example, acquired environmental data may be passed on to the radio link for transmission from mote 32a to mote 32b until data reaches a transmission node 32c coupled to the network 18. These radio links between motes 32a-d may have a transmission distance in the range of 10-200 feet, or greater. Alternatively, data transmitted from at least one of the motes 32c is provided to the database 16, or other network entities for analysis. If the analysed data indicates violation of the return policy, the item is immediately flagged as having been worn, used, washed and so forth. As an option, if the customer contact details are available, or can be derived from the store card, credit card, invoice or receipt, or other forms of payment, the customer may be notified of the violation of the return policy via any means of communication, such as snail mail, email, fax, IM, SMS, telephone or website. The sensor means may be automatically de-activated or “killed” subsequently to the transmittal of the data, or the data may be stored for a predetermined time as permitted by the return policy. Any subsequent attempts to return the item are curtailed due to the inactive sensor means or flagged item data by the system 10.

In another exemplary embodiment, at least one of the devices 32 is included with at least one hang-tag associated with the merchandise item, and having any of the above-noted sensing capability. For example, a hang-tag even if tucked away by a customer, as is a common practice of wardrobing, the sensor means 32 is still able sense the environment, such as, acoustic energy, vibrations, temperature, moisture, vital signs or location data, among others, in order to provide useful data determining whether the item would be eligible for return.

In another exemplary embodiment, at least one first device 32a is located at a first predetermined location on a clothing item, while at least one second device 32b is located at a second predetermined location. In a first state, say when the item is folded, hung, or otherwise not being worn, the devices 32a and 32b are separated by a predefined range, however, when worn the devices 32a and 32b are thus separated beyond the predefined range. By monitoring the distance between the devices 32a and 32b, the system can determine when the devices 32a and 32b are separated beyond the predefined range, and the duration of such an event. As an example, a shirt having a tubular body includes a device 32a is located at the front section of the shirt, while a device 32b is located at the back section of the shirt. When folded, or hung, the distance between them is typically less than 5 cm but when worn this distance increases beyond 5 cm depending on the wearer's physique. Other devices 32c and 32d may be placed on opposite sides of the sleeve opening or cuff. Should the devices 32a and the device 32b be separated beyond the predefined range, at least one of these devices 32a or 32b stores this information relating to such an event for future retrieval, or this event is transmitted to another device 32c, or to another device 32d coupled to the network, and the item is flagged.

In another exemplary embodiment, at least one first device 32a is included with at least one hang-tag associated with the merchandise item is located at a first predetermined location, while at least one-second device 32b is located at a second predetermined location and within a predefined range. Should the devices 32a and the device 32b be separated beyond the predefined range, at least one of these devices 32a or 32b stores this information relating to such an event for future retrieval, or this event is transmitted to another device 32c, or to another device, 32d coupled to the network, and the item is flagged. This method acts to counter removal of hang-tags, labels, or their subsequent re-attachment.

The merchandise data may include a description of the merchandise, pricing data, sale of markdown data, inventory data, SKU, merchant data, purchased merchandise data, returned merchandise data, statistical data, or a combination thereof.

In another embodiment, the system 10 is able to distinguish whether the customer returning the item for valid reasons. By analyzing the data, a determination may be made as to whether the garment has been worn on more that one occasion, the length of time it was worn, where it was worn, and so forth. Using this data, the system 10 can determine whether the garment is eligible for return, as such the system 10 may be customized to cater for a plurality of return policies. Valid reasons may include the garment is a poor fit than initial thought, or the garment's hue is not complementary of the customer, or that the garment has exposed the customer to unfavorable feedback.

In another exemplary embodiment, the server 14 is a stand-alone, and exchanges data with at least one second computing entity 30 in communication therewith.

In another exemplary embodiment; all or some of the analysis of the acquired data is performed by the sensor means 32a, which issues an output signal indicating the use or non-use of the article 12 when queried by the reader 34.

In another exemplary embodiment, the sensor means 32a may be RFID tag including a sensor. The first RFID tag 32a include a power source, and transmits ambient conditions data to a second RFID tag 32b, which may be configured to sense ambient conditions at its predefined location, or the first RFID tag 32a is interrogated by the second RFID tag 32b. The first RFID tag 32a and the second RFID tag 32b may thus exchange any data stored therein, such that at least one of the RFID tags 32a-d has the data of the other RFID tags 32a-d.

In another exemplary embodiment, the device 32, is a Micro-Electro-Mechanical Systems (MEMS) device having microelectronic integrated circuit which can sense the environment via sensors which gather information from the environment through measuring mechanical, thermal, biological, chemical, optical, and magnetic phenomena, among others, as stated above.

In another exemplary embodiment, at the time of purchase the customer is assigned unique customer data, such as, but not limited to, a unique identification number, and/or chooses a password or some form of challenge-response scheme, or the customer provides biometric data. The unique identification number or challenge response may be associated with, or comprises, a government issued ID or credit card/debit card information. At the point of purchase the unique identification number, challenge-response, or biometric data, or data related thereto, or a combination thereof, are stored on at least one of the devices 32a-d, and also stored in the database 18 and/or 22. The devices 32a-d may also include merchandise data, such as, description of the merchandise, pricing data, sale or markdown data, inventory data, SKU, merchant data, purchased merchandise data, returned merchandise data, statistical data, or a combination, thereof. The unique customer data, may be transmitted to a computing device associated with the customer. At the return station 30, the customer has to provide the unique identification number, challenge response, or biometric data, for verification. This data effectively determines whether the individual returning the item 12 is the same individual returning the item 12, thus mitigating return fraud involving receipt fraud, employee theft, stolen merchandise or counterfeit merchandise, and also mitigates or deters merchandise being returned to a different retailer. Also, an individual can return eligible merchandise 12 provided at least one of unique identification number, challenge response, or biometric data can be verified or authenticated, even without a receipt.

The system 10 supports various security features that ensure the integrity, confidentiality and privacy of information stored or transmitted, such as mutual authentication, where the devices 32a-d can verify whether the interrogator 34 is authentic and can prove its own authenticity to the interrogator 34 or retailer before starting a secure transaction. Another feature is information security to maintain data protection for information stored on devices 32a-d via encryption of the data on the devices 32a-d, and encryption for communication between the devices 32a-d and the interrogator 34 to prevent eavesdropping. Other security technologies may also be used to ensure information integrity. Additionally, the devices 32a-d may include built-in tamper-resistance by employing a variety of hardware and software capabilities that detect and react to tampering attempts and help counter possible attacks. The system 10 may also include the ability to process information and uniquely provide authenticated information access and protect the privacy of personal information. The devices 32a-d can verify the authority of the information interrogator 34 or retailer and then allow access only to the information required. Access to stored information can also be further protected by a challenge-response scheme, such as a personal identification number (PIN) or biometric to protect privacy and counter unauthorized access. The devices 32a-d may be inactivated or disabled following the return of the item 12, or after a predetermined time, and new devices 32a-d may be included with the item 12 for further re-sale, alternatively the acquired data, and any other data present, may be erased, modified or maintained to indicate previous use. Alternatively, after a predetermined time, such as a time frame stipulated by a retailer's return policy, the devices 32a-d may be inactivated, disabled, and or the data is erased, either automatically as per programming instructions on the devices 32a-d. Alternatively, a customer is provided with, a suitable code, instructions, or program means to allow reading the data associated with the devices 32a-d, or erasing the data with a suitable reader/writer 34. The code or signal may be provided via electronic transmission means or over-the-air.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceeding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

The embodiments of the invention in which an exclusive property or privilege is claimed, are defined as follows:

1. A method for enforcing a return policy relating to an article of merchandise following a predetermined event, the method having the steps of:
including at least one sensor with said article, said sensor for logging and recording ambient, conditions data;
including article data related to the article; in said sensor;
said sensor being located in predefined locations on said article to log ambient conditions data adjacent to said sensor;
acquiring said ambient conditions data from said sensors;
comparing said ambient conditions data to predetermined parameters associated with said return policy and analyzing said ambient conditions data to determine whether said recorded ambient conditions data is within, the predetermined parameters or outside the predetermined parameters;
issuing an output signal indicative of the outcome of said step of comparing said ambient conditions data to predetermined parameters;
wherein the output signal is correlated to article use or non-use following said predetermined event, and wherein said article is eligible for return based on said output signal and elapsed time following said predetermined event.

2. The method of claim 1 wherein said ambient conditions data includes data related to at least one of the following: temperature, moisture, humidity, chemicals, vibrations, pulse, location data, physiological data, biological data, electrical activity of the heart, or changes thereof.

3. The method of claim 2 wherein said ambient conditions data are analysed to determine whether the article has been used, worn, laundered or dry-cleaned, translocated while being worn.

4. The method of claim 1 wherein said sensor is activated following the predetermined event, and remains active for a predetermined period following said predetermined event.

5. The method of claim 4 wherein said the predetermined event is the time of purchase, and the predetermined period is time permissible for returning said article to the merchant.

6. The method of claim 5 wherein said sensor comprises a power source derived from any of: RF signals, a battery, solar energy or ambient light energy by nanoparticles, plastic solar cells, printable solar cells, or photovoltaic materials including electrically conductive polymers and nanostructures.

7. The method of claim 6 said sensor transmits ambient conditions data to a plurality of other sensors, and in response, said plurality of other sensors recording said ambient conditions data.

8. The method of claim 1 wherein said article data includes any of the following: date of purchase, merchant data, article data, temporal data, ambient conditions data related to predetermined event, inventory data, SKU, method of payment, customer data, salesperson data, point of sale data.

9. A system for mitigating return fraud of an article of merchandise following a predetermined event, the system including:
sensor means associated with the article for recording data related to ambient conditions post-purchase, said sensor means having data acquisition means for receiving the recorded data;
a return policy engine comprising an analysis engine, said analysis engine for receiving data from said data acquisition means; a merchant database, a customer database, a return policy database and a parameter database, with predetermined ambient conditions data coupled thereto, to determine whether an article has been used or not been used based on recorded data and predetermined ambient conditions data;
whereby said eligibility for return of said article is based on at least an outcome of a comparison between recorded data and predetermined ambient conditions data, elapsed time following said predetermined event, including merchant data, customer data and return policy data.

10. The system of claim 9 wherein said return policy database comprising conditions that must be met for eligible article returns or exchanged items, including return time frame following a purchase, original, condition of the article, non-use of the article, non-washed article, customer data, merchant data;
said merchant database comprises any of the following information: description of the merchandise, pricing data, sale or markdown data, gift item, inventory data, SKU, merchant data, customer data, purchased merchandise data, returned merchandise data, statistical data, or a combination thereof;
said parameter database having a predefined data set representative of acceptable data values corresponding to ambient conditions for eligibility for return of the article, as dictated by the return policy;
a customer database having customer related data comprising: name, address, contact information (email address, fax no., phone no., IM, SMS); ID (photograph, DL/passport/biometric); username/password; cookies, purchase history, return history, statistics.

11. The system of claim 10 wherein said ambient conditions data includes data related to at least one of the following: temperature, moisture, humidity, chemicals, vibrations, pulse, location data, physiological data, biological data, electrical activity of the heart, or changes thereof.

12. The system of claim 11 wherein said merchandise includes footwear, headgear, garments, clothing, jewelry, accessories, handbags, purses, neckties, socks, swimwear, under-garments, timepieces.

13. A method for mitigating return fraud by detecting the use or non-use of an article of merchandise after a predetermined event to determine whether said article is eligible for return to a merchant, the method having the steps of:
including at least one sensor with said article, said sensor for logging and recording ambient conditions data;
including data related to the article in said sensor;
said sensor being located in predefined locations on said article to log ambient conditions data adjacent to said sensor;
acquiring said ambient conditions data from said sensors;
comparing said ambient conditions data to predetermined parameters and analyzing said ambient conditions data to determine whether said recorded ambient conditions data is within the predetermined parameters or outside the predetermined parameters;
issuing an output signal indicative of the outcome of said step of comparing said ambient conditions data to predetermined parameters, said output signal being correlated to article use or non-use following said predetermined event;
determining the elapsed time following said predetermined event;
wherein eligibility for return for said article is based on said output signal and said elapsed time following said predetermined event.

14. The method of claim 13 wherein said data includes any of the following, date of purchase, merchant data, article data, time, ambient conditions data related to predetermined event, inventory data, SKU, method of payment, customer data, salesperson data, point of sale data.

15. The method of claim 14 wherein said ambient conditions data includes data related to at least one of the following: temperature, moisture, humidity, chemicals, vibrations, pulse, location data, physiological data, biological data, electrical activity of the heart, or changes thereof.

16. The method of claim 15 wherein at least one first sensor is included with at least one is located at a first predetermined location, while at least one second sensor is located at a second predetermined location, such that said at least one first sensor and said at least one second sensor are within a predefined range, said method including a steps of monitoring between said at least one first sensor and said at least one second sensor and determining whether said at least one first sensor and said at least one second sensor are within said predefined range or outside said predefined range, recording any event relating to separation of said at least one first sensor and said at least one second sensor beyond said predefined range, including duration of said separation.

17. The method of claim 16 wherein said at least one first sensor is located on a hang-tag or a label and said at least one second sensor is located elsewhere on said article.

18. The method of claim 17 wherein said event is transmitted to a device coupled to a network for transmittal to said merchant.

19. The method of claim 18 wherein said article is flagged by said merchant as being ineligible for return.

20. The method of claim 15 wherein said sensor is automatically deactivated or “killed” at the expiration of a predefined time period following said predetermined event, wherein said predefined time period is a time frame for which said article is eligible for return.
